(19) United States
(12) Patent Application Publication
(10) Pub. No.: US 2020/0377340 A1
(43) Pub. Date: Dec. 3, 2020

(54) MODERNIZATION OF AN ELEVATOR GROUP

(71) Applicants: THYSSENKRUPP AUFZUGSWERKE GMBH, Neuhausen (DE); thyssenkrupp AG, Essen (DE)

(72) Inventors: Marvin SCHNITZER, Neuhausen (DE); Falk ZEIGER, Kirchheim (DE); Manfred RANK, Neuhausen (DE); Felix SERWANE, Esslingen (DE); Stefan GERSTENMEYER, Filderstadt (DE)

(73) Assignees: THYSSENKRUPP AUFZUGSWERKE GMBH, Neuhausen (DE); thyssenkrupp AG, Essen (DE)

(21) Appl. No.: 16/611,441

(22) PCT Filed: Apr. 27, 2018
(86) PCT No.: PCT/EP2018/060823

§ 371 Date: Nov. 6, 2019

(30) Foreign Application Priority Data
May 8, 2017 (DE) 10 2017 207 750.6

(51) Int. Cl. B66B 19/00; B66B 1/46; B66B 1/34; B66B 1/24; B66B 3/00; B66B 13/14

(52) U.S. Cl. CPC B66B 19/007; B66B 1/468; B66B 1/3461; B66B 1/2458; B66B 2201/103; B66B 13/146; B66B 1/3492; B66B 2201/463; B66B 2201/4615; B66B 3/002

(57) ABSTRACT

Methods for the modernization of an elevator group which includes a plurality of elevators each with a car and an elevator controller for controlling the respective car. At least one input terminal is mounted for acquiring destination call signals and a group computer is installed in the course of the modernization process. The group computer is suitable for evaluation of the destination call signals as well as for the output of at least one first control signal. For each elevator furthermore a respective control unit is installed for reading in the first control signal and a control module is installed at the respective car for issuing an internal call for the respective car initiated by the first control signal.

The invention relates to a method for the modernization of an elevator group and a method for the operation of an elevator group during a modernization phase.

A method for the modernization of an elevator group with a plurality of elevators each with a car and an elevator controller for controlling the respective car is known from EP 1 319 624 and EP 1 319 625. Input terminals for the input of destination call signals and a computing unit for evaluating the destination call signal are installed here. The computing unit then controls the existing elevator controllers via a converter.

This method is relatively laborious, since it must be adapted individually to the existing elevator controllers. The elevator groups that are currently in operation comprise elevators from different manufacturers, and thus have entirely different elevator controllers with very different connections. In addition, very different signal types are expected for control by the elevator controllers found on the market. It is thus necessary to adapt the computing unit or the converter connected in between to the design type of the existing elevator controllers for every modernization project.

The object of the invention is to develop the method for the modernization of an elevator group in such a way that it can be employed with very different design types of elevator controllers without relatively large adaptations.

This object is achieved through a method for the modernization of an elevator group and a method for the operation of an elevator group with the features given in the independent claims. Advantageous developments emerge from the subsidiary claims, the following description, and the drawings.

The method according to the invention for the modernization of an elevator group is employed in an elevator group that comprises a plurality of elevators each with a car and an elevator controller for controlling the respective car. As part of the method, at least one input terminal is mounted for acquiring destination call signals, and in particular an input terminal for the acquisition of destination call signals is installed on each floor. A destination call signal comprises two items of information, namely an entry floor at which the call is issued and the destination floor that the passenger would like to reach. A destination call signal can, for example, be entered manually through a keypad. Only the destination floor is entered here, while the entry floor is determined on the basis of the position of the input terminal. A destination call signal can, alternatively, also be acquired in that the input terminal recognizes the passenger or a machine-readable medium (an RFID chip or a mobile telephone, for example) carried by the passenger. The information can then either be called up directly from the machine-readable medium or called up from a database on the basis of other information on the machine-readable medium (an identification number, for example).

At least one group computer for evaluation of the destination call signals and for the output of at least one first control signal is also installed according to the invention. Furthermore, for each elevator, a respective control unit is installed for reading in the first control signal. Additionally, for each elevator a respective control module is installed at the respective car for issuing an internal call for the respective car initiated by the first control signal.

The group computer in particular assigns each destination call signal to an elevator of the elevator group, and outputs a first control signal to the assigned elevator of the elevator group.

In the case of classic elevators, a distinction is made between internal calls and external calls. External calls are issued at the entry floor by passengers outside the car. A call button close to the entry is typically actuated for this purpose. The external call has the effect that the car approaches the entry floor and stops there to take passengers on board. Where appropriate the external call can also comprise information about the desired direction of travel (up/down). After the passengers have entered the car, they enter their desired destination floor through an operating panel in the interior of the car. This signal is referred to as an internal call.

The issue of an internal call is understood here to refer to the process that occurs on actuation of the corresponding button on the operating panel in the interior of the car. At least two control lines that are connected to the corresponding button are here briefly electrically connected. This initiates the generation of an internal call signal to the floor to which the button is assigned. Depending on the design type of the elevator, the car has different hardware for generating a suitable internal call signal and transmitting it to the elevator controller.

The installation method according to the invention now has the advantage that the group computer is given the ability to initiate an internal call to a desired floor at an arbitrary car by way of the respective control unit and the associated control module. An internal call initiated in this way is then processed in the usual way by the existing elevator controller of the respective elevator, so that the drive of the car is controlled in such a way that the car stops at the desired floor at the next opportunity. The existing elevator controller thus receives the same signal as if a passenger in the car had initiated a call to the desired floor. As a result of the initiation of internal calls at the car it is unnecessary to connect the group computer to the existing elevator controller either directly or via a signal converter. Instead, only an internal call is initiated at the car, so that the hardware present at the car, and the data connection between the car and the existing elevator controller, can continue to be used. It is not necessary to re-purpose any kind of servicing interface of the existing elevator controller to introduce calls. It is, furthermore, not necessary to generate a signal adapted to the existing elevator controller. Instead, the control module attached to the car merely initiates an internal call to the desired floor at the car. This means that the control module merely takes care of a brief electrical connection of the control lines that are connected to the corresponding button or which were connected prior to the modernization. An actuation of the button is thus simulated. Instead of a complicated signal converter that must be adapted to the design type of the existing elevator controller for every modernization, it is in this way possible to use simple relays in the control modules that merely establish a brief electrical connection. The wiring of the car is typically much more easily accessible than the connections of the elevator controllers, whereby the method is in addition faster and more efficient.

In a development of the method, a data connection is established in each case for all of the elevators of the plurality of elevators between the control unit and the control module of the same elevator. It is ensured in this way that the group computer can initiate an internal call in any arbitrary car of the elevator group.

In one special embodiment, the control modules are connected to an operating panel of the respective car for issuing the internal call in the operating panel. This has the advantage that it is possible to recognize immediately which control lines are connected to which buttons in the operating panel. The installation of the control modules is therefore particularly simple, since it is immediately possible to recognize which control lines must be briefly electrically connected to one another to issue an internal call to a desired floor. This reduces the probability of errors when installing the control modules. The control lines can, for example, be successively disconnected from the buttons in the operating panel and connected instead to switchable relays in the control module.

In an alternative embodiment, the control modules are connected to a terminal box which can, for example, be located on the roof of the car. In the case of some elevator designs, the control lines that are connected to the buttons in the operating panel are taken first to a terminal box and connected to the further hardware from there. In such cases it is easier to connect the control modules directly to the terminal box, since this is more easily accessible. The control lines leading from the buttons to the terminal box are, for example, successively disconnected and corresponding control lines taken instead to the control module with the switchable relays.

One special embodiment of the method, the control modules are connected to an operating panel of the respective car for displaying an acknowledgement of the internal call in the operating panel. This has the advantage that the passengers in the car are shown which calls have been properly received and are being processed by the car. The confirmation of the proper reception of a call is referred to as an acknowledgement.

Operating panels in a car typically have control lamps that are arranged next to or in the buttons of the operating panel. When a button is actuated, an internal call is thus initiated, and a corresponding signal is transmitted to the elevator controller. The elevator controller confirms reception of the internal call signal through an acknowledgement signal which, in turn, results in an acknowledgement display. This, typically, is an illumination of the associated control lamp. The acknowledgement display can, instead, also for example be a display indication of the number of the destination floor. In the method according to the invention, the group computer generates a first control signal that initiates the issue of an internal call at the respective car by the control module. In this special embodiment, the group computer additionally generates a corresponding acknowledgement signal, on the basis of which the control module brings about an acknowledgement display at the respective car. The passenger who enters the car is thus shown that his desired destination call has been properly received and is being processed.

Alternatively or in addition, a temporary display can be installed in the cars and connected to the control modules of the respective car for displaying an acknowledgement of the internal call. This has, for example, the advantage that a more noticeable acknowledgement display is permitted. In the case of some elevator types, furthermore, the acknowledgement is not shown by simple control lamps, but by a display on which, for example, the number of the destination floor is shown. While it would, in principle, also be possible to drive an existing display, this would, however, depending on the elevator group to be modernized, make an individual signal generation necessary for the drive. It is significantly easier to install a temporary display instead. Since the temporary display is also installed, the necessary display signals are known in advance, so that the temporary display can be driven without difficulty. Adapting the control module to the design type of the existing display is not necessary.

In a more developed form of embodiment, the control modules are connected to a door controller of the respective car, in order to initiate an opening and/or closing of a car door and/or to receive status information about a door status and forward it to the group computer via the control units. The door status can here, for example, contain the values of “opened”, “closed”, or “jammed”. This development has the advantage that the group computer can directly access the door controller via the control units and control modules. It is not necessary for this purpose that the group computer controls the existing elevator controller or directly accesses data from the existing elevator controller. An interface between the group computer and the existing elevator controller can in this way be omitted.

In one special embodiment of the invention, a position measuring system with a position sensor is installed in each case for each elevator at the car of the respective elevator. The control modules are furthermore connected to the position sensors of the respective cars in order to receive travel information from the position sensors and forward it to the group computer via the control units. The travel information can here comprise, for example, an absolute position and/or relative position and/or speed and/or direction of travel of the respective car. The position measuring system with position sensor is advantageously already the final position measuring system which, in any case, is being integrated for the first time into the elevator shaft in the course of the modernization.

In the known method for the modernization of an elevator group, the original position measuring system has always been relied upon. The travel information that is required for the group computer is then either drawn from the existing elevator controllers or directly accessed from the original position measuring system. Both variants have different disadvantages. On the one hand, some kind of interface must be created between the existing hardware and the new group computer. Due to the large number of elevator design types that are in operation, this entails an enormous effort, since the interface must be readapted every time to the elevator group that is to be modernized. On the other hand, the very reason elevator groups are modernized is that they no longer correspond to today's state of the art. The position measuring systems that are already present consequently do not meet the present standard, and do not supply the travel information with the necessary accuracy. Both disadvantages are avoided in that in the course of the modernization, the new position measuring system with the position sensors first installed at the cars. This ensures on the one hand that the interface to the position measuring system is properly known, and on the other hand, ensures that the travel information is determined and communicated with the necessary precision.

In the further development of the method, the control units are connected to the elevator controllers of the respective elevators in order to receive information from the elevator controllers and forward it to the group computer. The information is in particular the underlying status of the elevator controller, i.e. whether the corresponding elevator is in normal operation and calls can be accepted and processed. It would in principle also be possible for individual elevators of the elevator group to be taken out of operation for example for servicing and repair work. The group computer requires this information for assigning the destination calls. The information can, in addition, also comprise the door status of the respective car. In some elevator groups it is easier to receive this door status from the elevator controller than from the connection of the control module to the door controller described above.

In one special embodiment of the method, a data connection is established between the control unit and the control module of the same elevator in each case for all the elevators of the plurality of elevators, in that in each case a first adapter and a second adapter are installed that are suitable for modulating data signals onto the power network and for demodulating data signals that have been modulated on. The first adapter is connected here between the control unit and the local power network. The second adapter is correspondingly connected between the local power network and the corresponding control module. Since the car is, in any case, connected via a traveling cable to the local power network, it is particularly easily possible in this way to establish a data connection between the control unit and the control module of the same elevator. It is not necessary to lay a new data line to the respective car. Control signals can now be transferred between the two adapters via the local power network. Since a plurality of elevators of one elevator group share the same local power network, the two adapters of the same elevator group are correspondingly paired together, so that the data signals that are modulated on are given an individual identifier and/or encryption. The respective other adapter of the pair can thus filter out and demodulate the data signals that are intended for it. In this way, disturbances to the data connection between two adapters of a pair by other adapters in the same local power network are avoided.

The group computer is in particular designed to generate two first control signals on the basis of the destination call signal. One of the two first control signals here is adapted to initiate the issue of an internal call to the entry floor, and the other of the two first control signals is suitable for initiating the issue of an internal call to the destination floor. The group computer is thus designed to decompose the destination call signal received from an input terminal into two, individual, call signals. Only one first control signal for initiating a corresponding internal call is then transmitted to the respective control units. This has the advantage that all the more complex computing operations are carried out by the group computer, and the control units and control modules do not require any extensive logic circuits.

The invention further relates to a method for the operation of an elevator group, in particular during the modernization phase. The elevator group here comprises a plurality of elevators, each with a car and an elevator controller for controlling the respective car. The elevator group further comprises at least one input terminal for acquiring destination call signals and at least one group computer. Each elevator of the plurality of elevators here respectively comprises a control unit. For each elevator, furthermore, a respective control module is installed at the respective car of this elevator.

The method comprises at least the following steps:
a. acquisition of a destination call signal through the input terminal and transmission of the destination call signal to the group computer
b. evaluation of the destination call signal by the group computer, and selection of an elevator from the plurality of elevators for processing the destination call signal
c. generation of a first control signal by the group computer and transmission of the first control signal from the group computer to the control unit of the selected elevator
d. acquisition of the first control signal by the control unit of the selected elevator, generation of a second control signal by the control unit of the selected elevator, and transmission of the second control signal to the control module of the selected elevator
e. acquisition of the second control signal by the control module of the selected elevator and issue of an internal call for the car of the selected elevator by the control module of the selected elevator initiated by the second control signal.

The acquisition of the first control signal by the control unit of the selected elevator and the generation of a second control signal by the control unit of the selected elevator is to be understood in the sense of this application to include the case in which the first control signal and the second control signal are identical, and the control unit merely forwards the first control signal to the correct recipient. A conversion or processing of the first control signal does not necessarily have to be carried out. The enumeration of the “first” and “second” control signal is only used to enable a clear assignment to transmitter and recipient. First control signals travel from the group computer to the control unit, second control signals from the control unit to the control module.

In a development of the method, the group computer generates two first control signals on the basis of the destination call signal. One of the two first control signals here initiates the issue of an internal call to the entry floor and the other of the two first control signals initiates the issue of an internal call to the destination floor.

In a special embodiment of the operating method, the transmission of the second control signal takes place in that the second control signal is transmitted to a first adapter which modulates the second control signal onto the local power network and in that a second adapter demodulates the second control signal from the local power network and transmits it to the control module.

The operating method and its developed variants have the same advantages as were previously already described in relation to the modernization method.

The invention is explained in more detail below with reference to the figures. Shown schematically in each case,

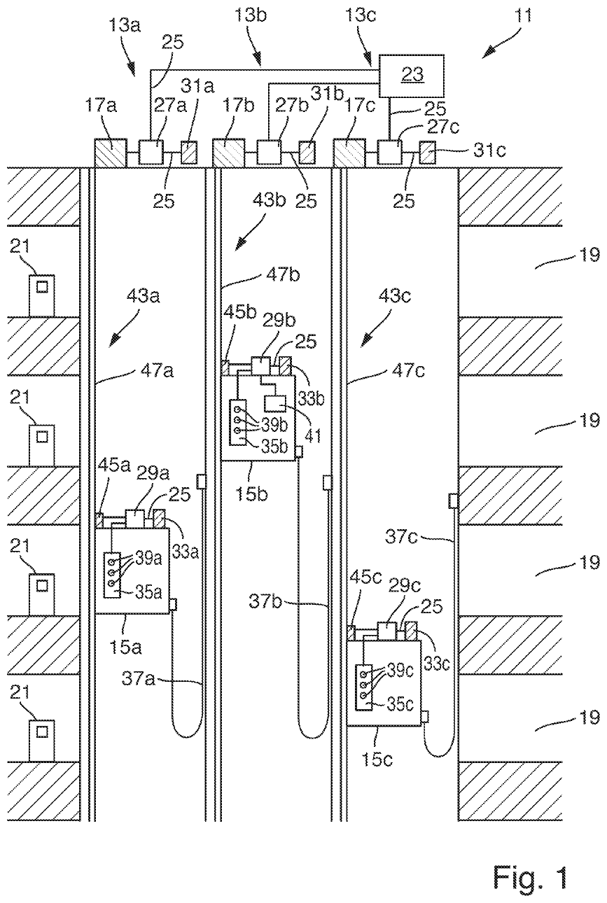

FIG. 1 shows a cross-section through an elevator group;

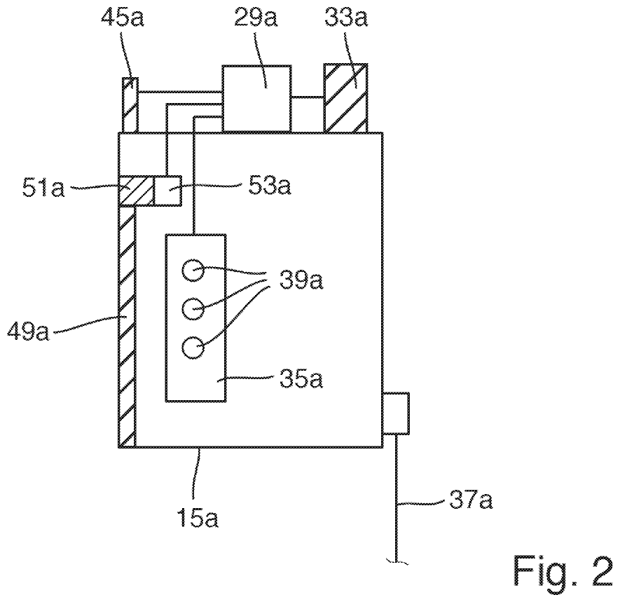

FIG. 2 shows a detailed illustration of a car from FIG. 1;

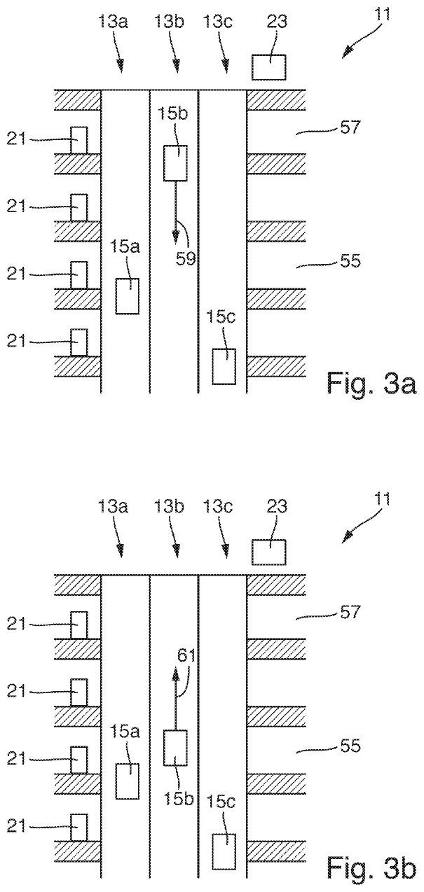

FIGS. 3a, 3b show the operational sequence of the operating method.

FIG. 1 shows schematically a cross-section through an elevator group 11. The elevator group 11 comprises a plurality of elevators. Three elevators 13a, 13b, 13c are shown here by way of example. Corresponding considerations apply with other numbers of elevators. Individual components of the three elevators 13a, 13b, 13c are explained in detail below. Reference signs with appended lower-case letters (a, b, c) are used here, just as for the three elevators. Components with the same appended lower-case letters in this case belong to the same elevator. The elevator 13a, for example, comprises a car 15a and an elevator controller 17a. The same applies to the further components described below.

Each of the three elevators 13a, 13b, 13c comprises a car 15a, 15b, 15c and an elevator controller 17a, 17b, 17c for controlling the respective car 15a, 15b, 15c. For the sake of a clear overview, illustration of the further components such as the elevator drive and the guide rails has been omitted. The cars 15a, 15b, 15c can travel between the floors 19. An input terminal 21 for acquiring destination call signals is mounted on each of the floors 19 for modernization purposes. A group computer 23 for evaluation of the destination call signal and for the output of at least one first control signal is also installed. The group computer 23 is connected in each case via a data line 25 to a control unit 27a, 27b, 27c of the respective elevator 13a, 13b, 13c. The control units 27a, 27b, 27c are connected in turn via a data line 25 respectively to a first adapter 31a, 31b, 31c. A control module 29a, 29b, 29c is installed in addition at each of the cars 15a, 15b, 15c. The control modules 29a, 29b, 29c are each connected via a data line 25 to a second adapter 33a, 33b, 33c. The control modules 29a, 29b, 29c are furthermore connected to an operating panel 35a, 35b, 35c of the respective car 15a, 15b, 15c.

All three elevators 13a, 13b, 13c further each comprise a traveling cable 37a, 37b, 37c through which the respective cars 15a, 15b, 15c are connected to the local power network. Typically, the data transmission between the operating panels 35a, 35b, 35c and the respective elevator controllers 17a, 17b, 17c is also further ensured through the traveling cable 37a, 37b, 37c.

A destination call signal is acquired by an input terminal 21 during operation of the elevator group 11. This takes place, for example, in that a passenger on an entry floor enters a desired destination floor at an input terminal 21. Alternatively a destination floor can also be read in by the input terminal 21 from a data carrier (a chip card or a mobile telephone, for example) being carried. The destination call signal thus comprises two items of information, namely the entry floor at which the call was issued and the destination floor that the passenger would like to reach. The destination call signal is forwarded from the input terminal 21 to the group computer 23. The group computer 23 is connected for this purpose with all the input terminals 21 via a data line (not illustrated) or a wireless network. The group computer 23 evaluates the destination call signal, and selects an elevator 13a, 13b, 13c from the plurality of elevators 13a, 13b, 13c for processing the destination call signal. Various criteria can be taken into account when selecting the elevator 13a, 13b, 13c. It is, for example, possible to take into account which car 15a, 15b, 15c is at that moment located nearest to the entry floor 19. It is further possible to take into account which car 15a, 15b, 15c is about to travel the section between the entry floor 19 and the destination floor 19 in any case as a result of calls that have already been assigned. It is assumed in the following description that the elevator 13a has been selected by the group computer 23 for processing the destination call signal. Corresponding considerations apply if one of the other elevators 13b, 13c is selected. On the basis of the selection of elevator 13a, the group computer 23 generates a first control signal and transmits this first control signal to the control unit 27a of the selected elevator 13a. The control unit 27a acquires the first control signal, and generates a second control signal that is transmitted to the control module 29a of the selected elevator 13a. This transmission of the second control signal to the control module 29a takes place in that the second control signal is transmitted to a first adapter 31a. The first adapter 31a is connected to the local power network, and modulates the second control signal onto the local power network. A second adapter 33a is also connected to the local power network, and demodulates the second control signal from the local power network. The second adapter 33a then transmits the second control signal to the control module 29 A. A data connection is thus established between the control unit 27a and the control module 29a of the elevator 13. The transmission between the first adapter 31a and the second adapter 33a utilizes the fact that the car 15a is connected to the local power network via the traveling cable 37a. The control module 29a can in this way be installed at the car 15a easily, and at the same time connected to the local power network. This in turn makes it possible for the second control signal to be transmitted via the local power network between the control unit 27a and the control module 29a with the aid of the two adapters 31a and 33a. It is therefore not necessary to install a new data line to the movable car 15a. The control module 29a at the car 15a acquires the second control signal. Initiated by the second control signal, the control module 29a issues an internal call for the car 15a. The control module 29a is connected to the operating panel 35a of the car 15a for this purpose. When issuing an internal call, a brief electrical connection is made by the control module 29a between the control lines that were connected to the corresponding button 39a of the operating panel 35a before the modernization. The elevator controller 17a thus receives the same signal as if a passenger in the interior of the car 15a had initiated an internal call at the operating panel 35a by actuating the button 39a. This internal call is processed in the usual way by the elevator controller 17a, so that the drive of the car 15a is controlled in such a way that the car 15a stops at the appropriate floor 19 at the next opportunity. The buttons 39a present in the operating panel 35a are thus without function to the extent that an actuation of the button 39a no longer initiates an internal call.

The newly installed group computer 23 can thus initiate the issue of arbitrary internal calls in arbitrary cars 15a, 15b, 15c of the elevators 13a, 13b, 13c in the manner described. These internal calls are then processed by the respective elevator controllers 17a, 17b, 17c in the usual manner, wherein the elevator controllers 17a, 17b, 17c carry out the concrete control of the respective cars 15a, 15b, 15c.

The control module 29a is furthermore connected to the operating panel 35a of the car 15a for displaying an acknowledgement of the internal call. In addition to the issue of an internal call for the car 15a, the control module 29a also gives a signal to the operating panel 35a, on the basis of which a display of an acknowledgement of the internal call is initiated. The buttons 39a that are without function are, for example, used to display the acknowledgement of the internal call. Even if an actuation of the button 39a does not initiate an internal call, an illumination of the control lamp in the button 39a nevertheless shows that an internal call that corresponds to an actuation of the button 39a is being processed. It is thus possible for the passengers inside the car 15a to recognize at any time which floors 19 are being approached on the basis of the illuminated buttons 39a. As an alternative to the use of the control lamps in the buttons 39a, 39b, 39c, it is also possible for a temporary display 41 to be used to display the internal calls. This is illustrated in FIG. 1 by way of example for car 15b. The temporary display 41 is installed in the car 15b and connected to the control module 29b of the car 15b for the display of an acknowledgement of internal calls. It is thus possible for a passenger inside the car 15b to recognize which floors 19 are being approached at any time on the temporary display 41. A temporary display is only illustrated in car 15b for the sake of greater clarity. The other cars 15a and 15c can be correspondingly equipped.

FIG. 1 further shows that a position measuring system 43a, 43b, 43c with a position sensor 45a, 45b, 45c is installed for each elevator 13a, 13b, 13c at the car 15a, 15b, 15c of the respective elevator 13a, 13b, 13c. Each position measuring system 43a, 43b, 43c at least one position sensor 45a, 45b, 45c that is connected to the respective car 15a, 15b, 15c. The position measuring system 43a, 43b, 43c furthermore comprises in each case a magnetic strip 47a, 47b, 47c that is installed along a travel section of the respective car 15a, 15b, 15c. The position sensors 45a, 45b, 45c act together with the respective magnetic strips 47a, 47b, 47c to determine the position of the corresponding car 15a, 15b, 15c. The control modules 29a, 29b, 29c are connected to the position sensors 45a, 45b, 45c in order to receive travel information from the position sensors 45a, 45b, 45c and forward it to the group computer 23 via the control units 27a, 27b, 27c. The travel information can here, for example, comprise an absolute position or a relative position of the respective car 15a, 15b, 15c. It is also possible that the control modules 29a, 29b, 29c receive information about the position of the respective car 15a, 15b, 15c, and determine a car velocity from the change of this position over time, and forward this to the group computer 23 via the control units 27a, 27b, 27c. An existing position measuring system 43a, 43b, 43c can, in principle, also be used. Since, however, very different position measuring systems are in use, it is advantageous to install a new position measuring system 43a, 43b, 43c for each elevator 13a, 13b, 13c with a position sensor 45a, 45b, 45c at the car 15a, 15b, 15c of the respective elevator 13a, 13b, 13c during the modernization of an elevator group 11. In this way it is ensured that the control modules 29a, 29b, 29c can be connected without difficulty to the position sensors 45a, 45b, 45c. No difficulties therefore occur with the mechanical connection (plug geometry), the electrical connection (assignment of connecting cables) or the data connection (unexpected signal forms).

The control units 27a, 27b, 27c here continue to be connected to the elevator controllers 17a, 17b, 17c of the respective elevators 13a, 13b, 13c, in order to receive information from the elevator controllers 17a, 17b, 17c and forward it to the group computer 23. This information contains, for example, the status of the elevator controller 17a, 17b, 17c, that is to say whether the respective elevator 13a, 13b, 13c is at the time ready to accept and process a travel order. This would not, for example, be the case in the presence of a malfunction or if the corresponding elevator 13a, 13b, 13c has been taken out of operation for some other reason (for example due to a fire alarm).

FIG. 2 shows a detailed illustration of the car 15a of FIG. 1. Further components that were left out of FIG. 1 for reasons of clarity are illustrated here. The further cars 15b and 15c can of course correspondingly also be designed with these additional components. The car 15a comprises a car door 49a that is connected to a door drive 51a. The door 49a is opened and closed with the aid of the door drive 51a. A door controller 53 A is connected to the door drive 51a. The door controller 53a is connected to the control module 29a in order to initiate an opening and/or closing of the car door 49a. The group computer 23 generates a first door signal for this purpose and transmits this first door signal to the control unit 27a of the selected elevator 13a. The control unit 27a acquires the first door signal, and generates a second door signal that is transmitted to the control module 29a of the selected elevator 13a. This transmission of the second door signal to the control module 29a takes place in that the second door signal is transmitted to a first adapter 31a. The first adapter 31a is connected to the local power network, and modulates the second door signal onto the local power network. A second adapter 33a is also connected to the local power network, and demodulates the second door signal from the local power network. The second adapter 33a then transmits the second door signal to the control module 29a. A data connection is thus established between the control unit 27a and the control module 29a of the elevator 13. The transmission between the first adapter 31a and the second adapter 33a exploits the fact that the car 15a is connected to the local power network via the traveling cable 37a. The control module 29a can in this way be installed at the car 15a easily, and at the same time connected to the local power network. This in turn makes it possible for the second door signal to be transmitted via the local power network between the control unit 27a and the control module 29a with the aid of the two adapters 31a and 33a. It is therefore not necessary to install a new data line to the movable car 15a. The control module 29a at the car 15a acquires the second door signal. Initiated by the second door signal, the control module 29a causes the door controller 53a to perform an opening or closing of the car door 49a.

The connection between the control module 29a and the door controller 53a has the further advantage that status information about a door status can be received by the control module 29a and can be forwarded to the group computer 23 via the corresponding control unit 27a. The transmission of the status information here takes place similarly to the signal transmission with the aid of the two adapters 31a and 33 A. The door status can here, for example, contain the values of “opened”, “closed”, or “jammed”.

As an alternative to the connection of the control module 29a with the door controller 53a, the status information relating to a door status can also be taken directly from the corresponding elevator controllers 17a. This is made possible through a suitable connection of the control unit 27a to the elevator controller 17a.

The method sequence for operation of the elevator group 11 is illustrated schematically in FIGS. 3a and 3b. The elevator group 11 is designed according to FIG. 1. The illustration of all the components is omitted in order to illustrate the method sequence schematically. Reference is made in this respect to FIG. 1. In a first method step, a destination call signal is acquired through the input terminal 21 at an entry floor 55. The destination call signal comprises two items of information, namely the entry floor 55 at which the call was issued and the destination floor 57 that the passenger would like to reach. The destination call signal is then forwarded from the input terminal 21 to the group computer 23. The group computer 23 evaluates the destination call signal, and selects an elevator from the plurality of elevators 13a, 13b, 13c for processing the destination call signal. In what follows this is, by way of example, elevator 13b with car 15b. In a next step, the group computer 23 generates a first control signal for issuing an internal call to the entry floor 55. This first control signal is forwarded by the group computer 23 to the control unit 27b of the selected elevator 13b. The control unit 27b then acquires the first control signal, generates a second control signal and transmits the second control signal to the control module 29b of the selected elevator 13 B. This transmission takes place in that the second control signal is transmitted to a first adapter 31b that modulates the second control signal onto the local power network, and in that a second adapter 33b demodulates the second control signal from the local power network and transmits it to the control module 29b. The control module 29b attached to the car 15b acquires the second control signal, and initiates the issue of an internal call for the car 15b of the selected elevator 13b to the entry floor 55. This internal call is processed in the usual way by the elevator controller 17b of the elevator group 13b. The elevator controller 17b thus receives the same signal as if a passenger in the car 15b had initiated a call to the entry floor 55. The elevator controller 17b processes this call in that the car 15b is moved to the entry floor 55. This is illustrated in FIG. 3a by the arrow 59.

FIG. 3b shows the situation in which the car 15b has reached the entry floor 55. The group computer 23 receives the information about reaching the entry floor 55 from, for example, the position measuring system 43b of the elevator 13 B. After reaching the entry floor 55, the group computer, still on the basis of the original destination call signal, generates a further first control signal. This first control signal then initiates the issue of an internal call to the destination floor 57. The first control signal is transmitted by the group computer 23 to the control unit 27b of the selected elevator 13b. The control unit 27b acquires the first control signal, generates a corresponding second control signal, and transmits this to the control module 29b of the elevator 13 B. This transmission takes place in that the second control signal is transmitted to a first adapter 31b that modulates the second control signal onto the local power network, and in that a second adapter 33b demodulates the second control signal from the local power network and transmits it to the control module 29b. The control module 29b attached to the car 15b acquires the second control signal, and initiates the issue of an internal call for the car 15b of the selected elevator 13b to the destination floor 57. The elevator controller 17b processes this call in that the car 15b is moved to the destination floor 57. This is illustrated in FIG. 3b by the arrow 61.

Fundamentally, the internal call to the destination floor 57 can also be initiated at a different time point. It is only necessary to ensure that the internal call to the entry floor 55 is handled first, and then the internal call to the destination floor 57. This is most easily ensured in that the internal call to the destination floor 57 is not issued until after the internal call to the entry floor has been dealt with. Depending on the specific model of the elevator controllers 17a, 17b, 17c it can, however, also be sufficient for the internal calls to be initiated in the correct sequence. The internal call to the entry floor can, alternatively, also be issued as a priority call that is to be handled urgently (in the context, for example, of a VIP circuit).

### LIST OF REFERENCE SIGNS

| | |
|---|---|
| 11 | Elevator group |
| 13a, 13b, 13c | Elevators |
| 15a, 15b, 15c | Cars |
| 17a, 17b, 17c | Elevator controllers |
| 19 | Floor |
| 21 | Input terminal |
| 23 | Group computer |
| 25 | Data line |
| 27a, 27b, 27c | Control units |
| 29a, 29b, 29c | Control modules |
| 31a, 31b, 31c | First adapter |
| 33a, 33b, 33c | Second adapter |
| 35a, 35b, 35c | Operating panels |
| 37a, 37b, 37c | Traveling cable |
| 39a, 39b, 39c | Button |
| 41 | Temporary display |
| 43a, 43b, 43c | Position measuring system |
| 45a, 45b, 45c | Position sensor |
| 47a, 47b, 47c | Magnetic strip |
| 49a | Car door |
| 51a | Door drive |
| 53a | Door controller |
| 55 | Entry floor |
| 57 | Destination floor |
| 59 | Arrow |
| 61 | Arrow |

1.-14. (canceled)

15. A method for the modernization of an elevator group, the elevator group including a plurality of elevators, each of the plurality of elevators having a car and an elevator controller for controlling the respective car, the method comprising:
mounting at least one input terminal configured to acquire destination call signals, installing at least one group computer configured to evaluate the destination call signals and configured to output a first control signal,
installing, for each elevator, a respective control unit configured to read the first control signal, and
installing, for each elevator, a respective control module at the respective car configured to issue an internal call for the respective car initiated by the first control signal.

16. The method of claim 15 wherein a data connection is established in each case for all the elevators of the plurality of elevators between the control unit and the control module of the same elevator.

17. The method of claim 15 wherein the control modules are connected to an operating panel of the respective car, the operating panel configured to issue the internal call in the operating panel.

18. The method of claim 17 wherein the control modules are connected to an operating panel of the respective car for displaying an acknowledgement of the internal call in the operating panel.

19. The method of claim 15 comprising temporary displays installed in the cars and each of said temporary displays connected to the control modules of the respective car for displaying an acknowledgement of the internal call.

20. The method of claim 15 wherein the control modules are connected to a door controller of the respective car, in order to initiate an opening and/or closing of a car door and/or to receive status information about a door status and forward it to the group computer via the control units.

21. The method of claim 15 wherein a position measuring system with a position sensor is installed in each case for each elevator at the car of the respective elevator.

22. The method of claim 21 wherein the control modules are connected to the position sensors of the respective cars in order to receive travel information from the position sensors and forward said travel information to the group computer via the control units.

23. The method of claim 15 wherein the control units are connected to the elevator controllers of the respective elevators, in order to receive information from the elevator controllers and forward it to the group computer.

24. The method of claim 15 wherein a data connection is established in each case for all the elevators of the plurality of elevators between the control unit and the control module of the same elevator, in that in each case a first adapter and a second adapter are installed that are suitable for modulating data signals onto the local power network and for demodulating data signals that have been modulated on.

25. The method of claim 15 wherein the group computer is designed to generate two first control signals on the basis of the destination call signal, wherein one of the two first control signals is adapted to initiate the issue of an internal call to the entry floor, and the other of the two first control signals is adapted to initiate the issue of an internal call to the destination floor.

26. A method for the operation of an elevator group, wherein the elevator group comprises a plurality of elevators each with a car and an elevator controller configured to control the respective car, wherein the elevator group comprises at least one input terminal for acquiring destination call signals, wherein the elevator group comprises a group computer and wherein each elevator of the plurality of elevators respectively comprises a control unit, wherein for each elevator a respective control module is installed at the respective car, the method comprising:
acquiring a destination call signal through the input terminal;
transmitting the destination call signal to the group computer;
evaluating, with the group computer, the destination call signal;
selecting an elevator from the plurality of elevators for processing the destination call signal;
generating, with the group computer, a first control signal;
transmitting the first control signal from the group computer to the control unit of the selected elevator;
acquiring, with the control unit of the selected elevator, the first control signal;
generating, with the control unit of the selected elevator, a second control signal;
transmitting the second control signal to the control module of the selected elevator;
acquiring, with the control module of the selected elevator, the second control signal; and
issuing, with the control module of the selected elevator initiated by the second control signal, an internal call for the car of the selected elevator.

27. The method of claim 26 wherein the group computer generates two first control signals on the basis of the destination call signal, wherein one of the two first control signals initiates the issue of an internal call to the entry floor and the other of the two first control signals initiates the issue of an internal call to the destination floor.

28. The method of claim 26 wherein the transmission of the second control signal to the control module of the selected elevator takes place in that the second control signal is transmitted to a first adapter which modulates the second control signal onto the local power network and wherein a second adapter demodulates the second control signal from the local power network and transmits it to the control module.
